(19) United States
(12) Patent Application Publication
(10) Pub. No.: US 2022/0121077 A1
(43) Pub. Date: Apr. 21, 2022

(54) ELECTROCHROMIC DEVICE INCLUDING A MEANS FOR MECHANICAL RESISTANCE AND A PROCESS OF FORMING THE SAME

(71) Applicant: SAGE ELECTROCHROMICS, INC., Faribault, MN (US)

(72) Inventors: Jean-Christophe Giron, Edina, MN (US); Leonard Bouzy, Maisons-Alfort (FR); Théo Chevallier, Paris (FR); Amaury Patissier, Bourg-la-Reine (FR); Nicolas Antoine Mercadier, Bulle (CH)

(21) Appl. No.: 17/450,863

(22) Filed: Oct. 14, 2021

Related U.S. Application Data
(60) Provisional application No. 63/092,306, filed on Oct. 15, 2020.

(51) Int. Cl. G02F 1/155; G02F 1/153

(52) U.S. Cl. CPC G02F 1/155; G02F 2202/28; G02F 2001/1555; G02F 1/1533

(57) ABSTRACT

An electrochromic device and method of forming the same is disclosed. The electrochromic device can include a first transparent conductive layer, an electrochromic layer, an electrolyte layer, a counter electrode layer, a second transparent conductive layer, and an adhesion layer between the counter electrode layer and the second transparent conductive layer, where the electrochromic device can undergo at least 2,000 cycles in a Nylon brush test before type 2 defects form. The method can include depositing an electrochromic layer over a first transparent conductive layer, depositing an electrolyte layer, depositing a lithium layer, depositing a counter electrode layer over the lithium layer, depositing a second transparent conductive layer, and heating the layers to form an electrochromic stack, where the lithium layer is combined with the counter electrode layer.

### CROSS-REFERENCE TO RELATED APPLICATIONS

This application claims priority under 35 U.S.C § 119(e) to U.S. Provisional Application No. 63/092,306, entitled “ELECTROCHROMIC DEVICE INCLUDING A MEANS FOR MECHANICAL RESISTANCE AND A PROCESS OF FORMING THE SAME,” by Jean-Christophe GIRON et al., filed Oct. 15, 2020, which is assigned to the current assignee hereof and incorporated by reference in its entirety.

### FIELD OF THE DISCLOSURE

The present disclosure is directed to electrochromic devices, and more specifically to electrochromic devices including means for preventing mechanical wear and processes of forming the same.

### BACKGROUND

An electrochemical device can include an electrochromic stack where transparent conductive layers are used to provide electrical connections for the operation of the stack. Electrochromic (EC) devices employ materials capable of reversibly altering their optical properties following electrochemical oxidation and reduction in response to an applied potential. The optical modulation is the result of the simultaneous insertion and extraction of electrons and charge compensating ions in the electrochemical material lattice.

EC devices have a composite structure through which the transmittance of light can be modulated. A typical layer solid-state electrochromic device in cross-section having the following superimposed layers: a first transparent conductive layer which serves to apply an electrical potential to the electrochromic device, an electrochromic electrode layer which produces a change in absorption or reflection upon oxidation or reduction, an electrolyte layer that allows the passage of ions while blocking electronic current, a counter electrode layer which serves as a storage layer for ions when the device is in the bleached or clear state, and a second transparent conductive layers which also serves to apply an electrical potential to the electrochromic device. Each of the aforementioned layers is typically applied sequentially on a substrate under certain process conditions. However, once formed, the EC device can become sensitive to mechanical wear, such as scratches, that delaminate the device and cause shorts within the film.

As such, further improvements of electrochromic devices and window designs are desired.

### BRIEF DESCRIPTION OF THE DRAWINGS

Embodiments are illustrated by way of example and are not limited in the accompanying figures.

FIG. 1 is a schematic cross-section of an electrochromic device with an improved film structure in accordance with an embodiment of the present disclosure.

FIG. 2 is a flow chart depicting a process for forming an electrochromic device in accordance with an embodiment of the current disclosure.

FIGS. 3A-3E are a schematic cross-section of an electrochromic device at various stages of manufacturing in accordance with an embodiment of the present disclosure.

FIG. 4 is a schematic cross-section of another electrochromic device with an improved film structure in accordance with an embodiment of the present disclosure.

FIG. 5 is a flow chart depicting a process for forming an electrochromic device in accordance with an embodiment of the current disclosure.

FIGS. 6A-6G are a schematic cross-section of an electrochromic device at various stages of manufacturing in accordance with an embodiment of the present disclosure.

FIG. 7 is a schematic illustration of an insulated glazing unit according the embodiment of the current disclosure.

Skilled artisans appreciate that elements in the figures are illustrated for simplicity and clarity and have not necessarily been drawn to scale. For example, the dimensions of some of the elements in the figures may be exaggerated relative to other elements to help to improve understanding of the embodiments of the invention.

### DETAILED DESCRIPTION

The following description in combination with the figures is provided to assist in understanding the teachings disclosed herein. The following discussion will focus on specific embodiments and implementations of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or.

The use of “over” is employed to describe elements and components described herein. This description includes variations meant to include layers which are or are not in direct contact with the others.

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

The mechanical resistance of the examples per the invention has been characterized using the Erichsen Brush Test. The Erichsen brush test (EBT), as known as Washability and Scrub Resistance Tester 494, is a mechanical test which allowed the evaluation of the mechanical resistance of a glass coating to a wet brush. Such test simulates one of the steps during the processability of a glass coating, which is the washing machine. The equipment is composed by a container filled with deionized water (DI) and a spare pull cable system where the brush is connected. The number of cycles is controlled by a simple pre-setting counter. The sample (10×30 cm²) is placed in the center of the container under DI water, and then the spare pull cable system with the brush is connected. Note the brush is always in contact with the sample. With the test conditions described in ASTM D2486: a Nylon brush is used, charged with 454 g, and the sample immersed in De-Ionized water. The evaluation of the coating resistance to the brush is performed by optical visualization. The operator classifies the degradation observed after test using the following criteria (Table 1).

TABLE 1

| Classification | Observation |
|---|---|
| type 0 | No visible scratch/degradation |
| type 1 | No visible scratch but color degradation |
| type 2 | Few discontinuous scratches on part of the brush track |
| type 3 | Discontinuous scratches on all the brush track |
| type 4 | Continuous scratches on the part of the brush track |
| type 5 | Continuous scratches on all the brush track |

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

In an aspect, an electrochromic device can include a substrate, an electrochromic layer or a counter electrode layer over the substrate, a first transparent conductive layer over the substrate, a second transparent conductive layer, and an adhesion layer disposed between second transparent conductive layer and the counter electrode layer.

In another aspect, an electrochromic device can include a substrate, an electrochromic layer or a counter electrode layer over the substrate, a first transparent conductive layer over the substrate, and a second transparent conductive layer in direct contact with the counter electrode layer without any intervening layers.

The incorporation of only a single lithiation step between the counterelectrode and the second transparent conductive layer improves the mechanical strength of the electrochromic device and increases the resistance to mechanical stress.

The embodiments as illustrated in the figures and described below help in understanding particular applications for implementing the concepts as described herein. The embodiments are exemplary and not intended to limit the scope of the appended claims.

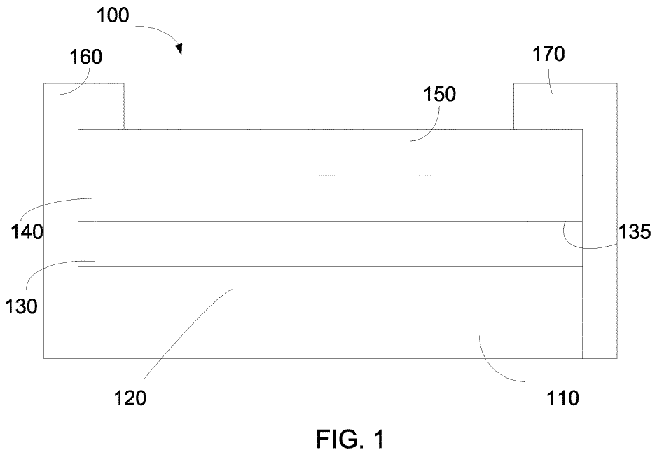

FIG. 1 is a schematic cross-section of an electrochromic device with an improved film structure in accordance with an embodiment of the present disclosure. For purposes of illustrative clarity, the electrochemical device 100 is a variable transmission device. In one embodiment, the electrochemical device 100 can be an electrochromic device. In another embodiment, the electrochemical device 100 can be a thin-film battery. However, it will be recognized that the present disclosure is similarly applicable to other types of scribed electroactive devices, electrochemical devices, as well as other electrochromic devices with different stacks or film structures (e.g., additional layers). With regard to the electrochemical device 100 of FIG. 1, the device 100 may include a substrate 110, a first transparent conductor layer 120, a cathodic electrochemical layer 130, an anodic electrochemical layer 140, and a second transparent conductor layer 150.

The substrate 110 can include a material selected from the group consisting of a glass substrate, a sapphire substrate, an aluminum oxynitride (AlON) substrate, a spinel substrate, or a transparent polymer. In another embodiment, the substrate 110 can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The substrate 110 may or may not be flexible. In a particular embodiment, the substrate 110 can be float glass or a borosilicate glass and have a thickness in a range of 0.5 mm to 12 mm thick. The substrate 110 may have a thickness no greater than 16 mm, such as 12 mm, no greater than 10 mm, no greater than 8 mm, no greater than 6 mm, no greater than 5 mm, no greater than 3 mm, no greater than 2 mm, no greater than 1.5 mm, no greater than 1 mm, or no greater than 0.01 mm.

In a particular embodiment, the transparent substrate 110 can include ultra-thin glass that is a mineral glass having a thickness in a range of 50 microns to 300 microns. In another embodiment, the laminate can include a solar control layer that reflects ultraviolet radiation or a low emissivity material.

In an embodiment, the transparent substrate 110 can be a glass substrate that can be a mineral glass including SiO₂ and one or more other oxides. Such other oxides can include Al₂O₃, an oxide of an alkali metal, an oxide of an alkaline earth metal, B₂O₃, ZrO₂, P₂O₅, ZnO, SnO₂, SO₃, As₂O₂, or Sb₂O₃. The transparent substrate 110 may include a colorant, such as oxides of iron, vanadium, titanium, chromium, manganese, cobalt, nickel, copper, cerium, neodymium, praseodymium, or erbium, or a metal colloid, such as copper, silver, or gold, or those in an elementary or ionic form, such as selenium or sulfur. In an embodiment in which the transparent substrate 110 is a glass substrate, the glass substrate is at least 50 wt % SiO₂. In some applications, the glass substrate is desired to be clear, and thus, the content of colorants is low. In a particular embodiment, the iron content is less than 200 ppm. In an embodiment, the SiO₂ content is in a range of 50 wt % to 85 wt %. Al₂O₃ may help with scratch resistance, for example, when the major surface is along an exposed surface of the laminate being formed. When present, Al₂O₃ content can be in a range of 1 wt % to 20 wt %.

The glass substrate can include heat-strengthened glass, tempered glass, partially heat-strengthened or tempered glass, or annealed glass. “Heat-strengthened glass” and “tempered glass”, as those terms are known in the art, are both types of glass that have been heat treated to induce surface compression and to otherwise strengthen the glass. Heat-treated glasses are classified as either fully tempered or heat-strengthened. The term “annealed glass” means glass produced without internal strain imparted by heat treatment and subsequent rapid cooling. Thus annealed glass only excludes heat-strengthened glass or tempered glass. The glass substrate can be laser cut.

Transparent conductive layers 120 and 150 can include a conductive metal oxide or a conductive polymer. Examples can include a tin oxide or a zinc oxide, either of which can be doped with a trivalent element, such as Al, Ga, In, or the like, a fluorinated tin oxide, or a sulfonated polymer, such as polyaniline, polypyrrole, poly(3,4-ethylenedioxythiophene), or the like. In another embodiment, the transparent conductive layers 120 and 150 can include gold, silver, copper, nickel, aluminum, or any combination thereof. The transparent conductive layers 120 and 150 can include indium oxide, indium tin oxide, doped indium oxide, tin oxide, doped tin oxide, zinc oxide, aluminum zinc oxide, doped zinc oxide, ruthenium oxide, doped ruthenium oxide and any combination thereof. The transparent conductive layers 120 and 150 can have the same or different compositions. The transparent conductive layers 120 and 150 can have a thickness between 10 nm and 600 nm. In one embodiment, the transparent conductive layers 120 and 150 can have a thickness between 200 nm and 500 nm. In one embodiment, the transparent conductive layers 120 and 150 can have a thickness between 320 nm and 460 nm. In one embodiment the first transparent conductive layer 120 can have a thickness between 10 nm and 600 nm. In one embodiment, the second transparent conductive layer 150 can have a thickness between 80 nm and 600 nm. In one embodiment, the transparent conductive layer 120 overlies the substrate 110.

The layers 130 and 140 can be electrode layers, wherein one of the layers may be a cathodic electrochemical layer, and the other of the layers may be an anodic electrochromic layer (also referred to as a counter electrode layer). In one embodiment, the cathodic electrochemical layer 130 can be an electrochromic layer. The cathodic electrochemical layer 130 can include an inorganic metal oxide material, such as WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), or any combination thereof and can have a thickness in a range of 40 nm to 600 nm. In one embodiment, the cathodic electrochemical layer 130 can have a thickness between 100 nm to 500 nm. In one embodiment, the cathodic electrochemical layer 130 can have a thickness between 300 nm to 500 nm. The cathodic electrochemical layer 130 can include lithium, aluminum, zirconium, phosphorus, nitrogen, fluorine, chlorine, bromine, iodine, astatine, boron; a borate with or without lithium; a tantalum oxide with or without lithium; a lanthanide-based material with or without lithium; another lithium-based ceramic material; or any combination thereof.

The counter electrode layer 140 can include any of the materials listed with respect to the cathodic electrochromic layer 130 or Ta₂O₅, ZrO₂, HfO₂, Sb₂O₃, or any combination thereof, and may further include nickel oxide (NiO, Ni₂O₃, or combination of the two), and Li, Na, H, or another ion and have a thickness in a range of 40 nm to 500 nm. In one embodiment, the counter electrode layer 140 can have a thickness between 150 nm to 300 nm. In one embodiment, the counter electrode layer 140 can have a thickness between 250 nm to 290 nm. In some embodiments, lithium may be inserted into at least one of the first electrode 130 or second electrode 140. In another embodiment, a mobile element may be inserted into both the first electrode 130 and the second electrode 140. The mobile element can migrate to and provide color for either the electrochromic layer 130 or the counter electrode layer 140 as the electrochromic device changes from a clear to tinted state. In one embodiment, the mobile element can be deposited on the first transparent conductive layer 120—prior to any other layer deposition—and then migrate to the first electrode 130. In another embodiment, the mobile element can be deposited after an adhesion layer (as described below) and migrate to the second electrode 140. The mobile element can include silver, sodium, hydrogen, lithium, or any combination therein.

In another embodiment, a separate lithiation operation, such as sputtering lithium, may be performed. In one embodiment, the lithium may be co-sputtered with the electrochromic layer 130 using a lithium target. In another embodiment, the lithium may be sputtered with the electrochromic layer 130 using a lithium tungsten oxide target. In such a lithiation operation, the thickness of the lithium may be between 1 μg/cm² and 10 μg/cm². In one embodiment, the lithiation operation may be performed before the deposition of the electrochemical layer 130. In another embodiment, the lithation operation may be performed after the deposition of the counter electrode layer 140. For example, a lithium layer may be deposited in between the first transparent conductive layer 120 and the electrochemical layer 130. In another embodiment, a lithium layer can be deposited after the second transparent conductive layer 150. In yet another embodiment, the lithium layer can be deposited in combination with an intermediate layer such that the lithium is not in direct contact with either the electrochemical layer 130 or the counter electrode layer 140. In such an example, the intermediate layer can have a composition that allows the lithium to migrate to and lithiate the electrochemical layer 130 and/or the counter electrode layer 140. In one embodiment, the intermediate layer can be the adhesion layer described below. In another embodiment, the adhesion layer can include a material selected from the group consisting of a silicate, an aluminum silicate, an aluminum borate, a borate, a zirconium silicate, a niobate, a borosilicate, a phosphosilicate, a nitride, an aluminum fluoride, and another suitable ceramic material. In one embodiment, the lithium layer can be between the electrochemical layer 130 and the counter electrode layer 140 without being in direct contact with either the electrochemical layer 130 or the counter electrode layer 140.

An electrolyte layer 135 can be between the electrochromic layer 130 and the counter electrode layer 140. The electrolyte layer 135 includes a solid electrolyte that allows ions to migrate through the electrolyte layer 135 as an electrical field across the electrolyte layer is changed from the high transmission state to the low transmission state, or vice versa. In an embodiment, the electrolyte layer 135 can be a ceramic electrolyte. In another embodiment, the electrolyte layer 135 can include a silicate-based or borate-based material. The electrolyte layer 135 may include a silicate, an aluminum silicate, an aluminum borate, a borate, a zirconium silicate, a niobate, a borosilicate, a phosphosilicate, a nitride, an aluminum fluoride, or another suitable ceramic material. Other suitable ion-conducting materials can be used, such as tantalum pentoxide or a garnet or perovskite material based on a lanthanide-transition metal oxide. In another embodiment, as formed, the electrolyte layer 135 may include mobile ions. Thus, lithium-doped or lithium-containing compounds of any of the foregoing may be used. Alternatively, a separate lithiation operation, such as sputtering lithium, may be performed. In such a lithiation operation, the thickness of the lithium may be between 1 μg/cm² and 10 μg/cm². The electrolyte layer 135 may include a plurality of layers having alternating or differing materials, including reaction products between at least one pair of neighboring layers. The thickness of the electrolyte layer 135 can be in a range of 1 nm to 20 nm. The electrolyte layer 135 may have a thickness of no greater than 10 nm, such as no greater than 5 nm, no greater than 4 nm, no greater than 3 nm, no greater than 2 nm, or no greater than 1 nm.

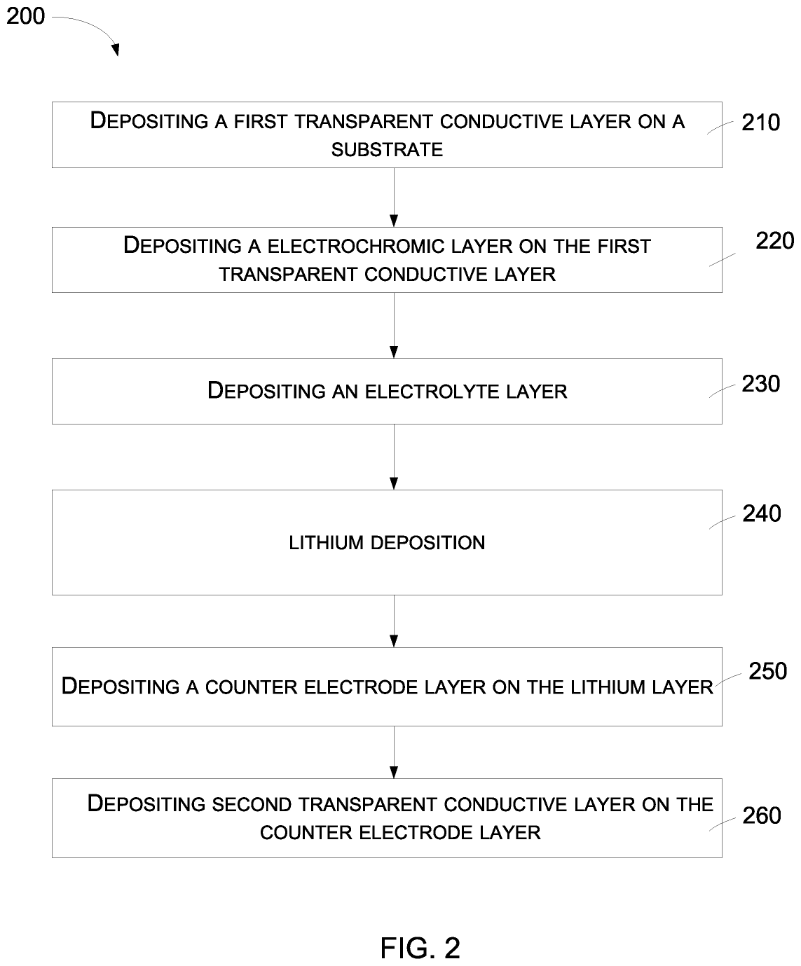

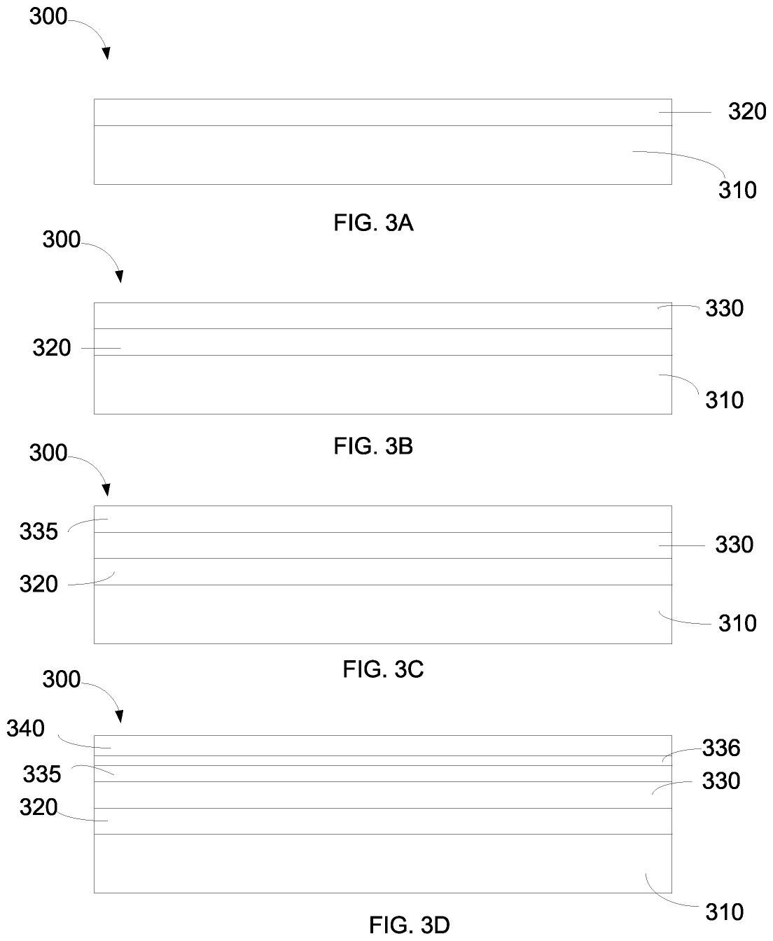

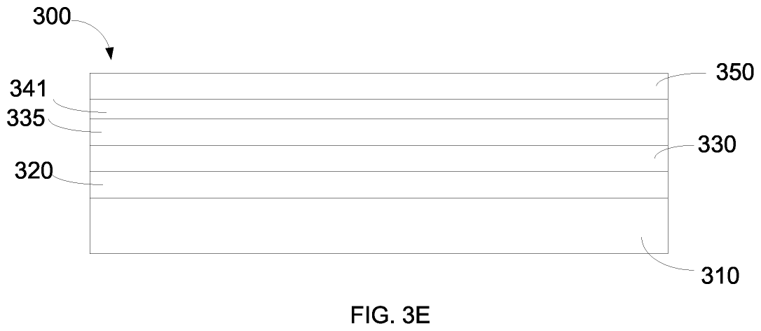

In another embodiment, the device 100 may include a plurality of layers between the substrate 110 and the first transparent conductive layer 120. In one embodiment, an antireflection layer is between the substrate 110 and the first transparent conductive layer 120. The antireflection layer can include SiO₂, NbO₂, and can be a thickness between 20 nm to 100 nm. The device 100 may include at least two bus bars. A bus bar 160 can be electrically connected to the first transparent conductive layer 120 and a bus bar 170 can be electrically connected to the second transparent conductive layer 150. FIG. 2 is a flow chart depicting a process 200 for forming an electrochromic device in accordance with an embodiment of the current disclosure. FIGS. 3A-3E are a schematic cross-section of an electrochromic device 300 at various stages of manufacturing in accordance with an embodiment of the present disclosure. The electrochromic device 300 can be the same as the electrochromic device 100 described above. The process can include providing a substrate 310. The substrate 310 can be similar to the substrate 110 described above. Forming the electrochromic device can be performed within a vertical coater, subcentral coater, as the substrate is in the vertical position, horizontal position, or a combination thereof. At operation 210, a first transparent conductive layer 320 can be deposited on the substrate 310, as seen in FIG. 3A. The first transparent conductive layer 320 can be similar to the first transparent conductive layer 120 described above. In one embodiment, the deposition of the first transparent conductive layer 320 can be carried out by sputter deposition at a power of between 5 kW and 20 kW, at a temperature between 20° C. and 500° C., in a sputter gas including oxygen and argon at a rate between 0.1 m/min and 0.5 m/min. In one embodiment, the sputter gas includes between 40% and 80% oxygen and between 20% and 60% argon. In one embodiment, the sputter gas includes 50% oxygen and 50% argon. In one embodiment, the temperature of sputter deposition can be between 20° C. and 350° C. In another embodiment, the temperature of sputter deposition can be between 23° C. and 200° C. In one embodiment, the first transparent conductive layer 320 can be carried out by sputter deposition at a power of between 10 kW and 15 kW.

In one embodiment, an intermediate layer can be deposited between the substrate 310 and the first transparent conductive layer 320. In an embodiment, the intermediate layer can include an insulating layer such as an antireflective layer. The antireflective layer can include a silicon oxide, niobium oxide, or any combination thereof. In a particular embodiment, the intermediate layers can be an antireflective layer that can be used to help reduce reflection. The antireflective layer may have an index of refraction between the underlying layers (refractive index of the underlying layers can be approximately 2.0) and clean, dry air or an inert gas, such as Ar or N₂ (many gases have refractive indices of approximately 1.0). In an embodiment, the antireflective layer may have a refractive index in a range of 1.4 to 1.6. The antireflective layer can include an insulating material having a suitable refractive index. In a particular embodiment, the antireflective layer may include silica. The thickness of the antireflective layer can be selected to be thin and provide the sufficient antireflective properties. The thickness for the antireflective layer can depend at least in part on the refractive index of the electrochromic layer 330 and counter electrode layer 340. The thickness of the intermediate layer can be in a range of 20 nm to 100 nm.

At operation 220 and as seen in FIG. 3B, an electrochromic layer 330 may be deposited on the first transparent conductive layer 320. The electrochromic layer 330 can be similar to the electrochromic layer 130 described above. In one embodiment, the deposition of the electrochromic layer 330 may be carried out by sputter deposition of tungsten, at a temperature between 23° C. and 500° C., in a sputter gas including oxygen and argon. In one embodiment, the sputter gas includes between 40% and 80% oxygen and between 20% and 60% argon. In one embodiment, the sputter gas includes 50% oxygen and 50% argon. In one embodiment, the temperature of sputter deposition is between 100° C. and 350° C. In one embodiment, the temperature of sputter deposition is between 200° C. and 300° C. An additionally deposition of tungsten may be sputter deposited in a sputter gas that includes 100% oxygen.

At operation 230 and as seen in FIG. 3C, an electrolyte layer 335 may be deposited on the electrochromic layer 330. The electrolyte layer 335 can be similar to the electrolyte layer 135 described above. In one embodiment, the deposition of the electrolyte layer 335 may be carried out by sputter deposition of silica and lithium at a power of between 5 kW and 12 kW. In one embodiment, the power is pulsed. In another embodiment, the sputter target of lithium can be rotated to point away from the substrate such that deposition of the electrolyte layer 335 can be carried out by sputter deposition of silica at a power of between 5 kW and 12 kW. The deposition of the electrolyte layer may be at a temperature between 20° C. and 500° C. in a sputter gas including oxygen and argon. In one embodiment, the temperature of sputter deposition is between 23° C. and 450° C. In another embodiment, the deposition of the electrolyte layer 335 may be carried out in a sputter gas including between 0% and 5% oxygen and between 100% to 95% argon. In one embodiment, the sputter gas includes between 40% and 80% oxygen and between 20% and 60% argon. In one embodiment, the electrolyte layer 335 may be deposited to form a layer with a thickness between 1 nm and 12 nm. In one embodiment, the metal layer may have a thickness of no greater than 5 nm, such as no greater than 4 nm, no greater than 3 nm, no greater than 2 nm, or no greater than 1 nm.

At operation 240, an additional lithium layer 336 deposition may occur. In one embodiment the lithium layer 336 may be sputtered on top of the electrolyte layer 335. As will be discussed later, the lithium layer 336 may diffuse into the counter electrode layer 340 during a firing step. The lithiation of the counter electrode layer 340 may be completed before the deposition of any subsequent layers, such as the second electrode layer 360. In one embodiment, after sputtering additional lithium on the electrolyte layer 335, the stack of layers can break vacuum. In another embodiment, lithiation can occur in a controlled environment, without vacuum break, but instead by introducing an oxidizing agent into the controlled environment.

In one embodiment the substrate 310, the first transparent conductive layer 320, the electrolyte layer 335, and the electrochromic layer 330 may be heated at a temperature between 23° C. and 500° C. in atmospheric air for between 1 min. and 30 min. In other words, the substrate and subsequent deposited layers may break vacuum before being heated. In one embodiment, the substrate and subsequent layers may be heated in atmospheric air for between 1 min. and 5 min. The substrate 310, the first transparent conductive layer 320, the electrolyte layer 335, and the electrochromic layer 330 may be heated by the plasma source before subsequent deposition of layers. In one embodiment, substrate 310, the first transparent conductive layer 320, the electrolyte layer 335, and the electrochromic layer 330 may be heated at a temperature between 200° C. and 500° C.

At operation 250, after heating the layers, a counter electrode layer 340 may be deposited on the lithium layer 336. The counter electrode layer 340 can be similar to the counter electrode layer 140 described above. In one embodiment, the deposition of the counter electrode layer 340 may be carried out by sputter deposition of tungsten, nickel, and lithium, at a temperature between 20° C. and 50° C., in a sputter gas including oxygen and argon. In one embodiment, the sputter gas includes between 60% and 80% oxygen and between 20% and 40% argon. In one embodiment, the temperature of sputter deposition is between 22° C. and 32° C.

At operation 260, a second transparent conductive layer 350 may be deposited on the counter electrode layer 340. The second transparent conductive layer 350 can be similar to the second transparent conductive layer 150 described above. In one embodiment, the deposition of the second transparent conductive layer 350 may be carried out by sputter deposition at a power of between 5 kW and 20 kW, at a temperature between 20° C. and 50° C., in a sputter gas including oxygen and argon. In one embodiment, the sputter gas includes between 1% and 10% oxygen and between 90% and 99% argon. In one embodiment, the sputter gas includes 8% oxygen and 92% argon. In one embodiment, the temperature of sputter deposition is between 22° C. and 32° C. In one embodiment, the substrate 310, first transparent conductive layer 320, the electrochromic layer 330, the electrolyte layer 335, the lithium layer 336, the counter electrode layer 340, and the second transparent conductive layer 350 may be heated a at a temperature between 300° C. and 500° C. for between 2 min and 10 min. In one embodiment, the stack is heated at a temperature between 300° C. and 450° C. As the stack is heated, the lithium layer 336 deposited in between the electrolyte layer 335 and the counter electrode layer 340 may be diffused into the counter electrode layer 340 forming a lithiated counter electrode layer 341, as seen in FIG. 3E. In one embodiment, additional layers may be deposited on the second transparent conductive layer 350, however no additional lithium is deposited after the counter electrode layer 340 is deposited. Any of the electrochemical devices can be subsequently processed as a part of an insulated glass unit. Overtime and after repeated wear from mechanical stress, layers within the electrochemical device can begin to separate and degrade. The inventors have discovered that in general the interface most susceptible to degradation is between the counter electrode layer and the second transparent conductive layer. As such, over time the interface between those two layers begins to degrade causing the electrochemical device to fail. However, by manufacturing an electrochemical device as described above, specifically with a single lithium deposition between the electrolyte layer 335 and the counter electrode layer 340, the adhesion between the counter electrode layer and the second transparent conductive layer improves while maintaining the ion mobility necessary for switching between a clear state and tinted state. In other words, the functionality of the counter electrode layer 340 is maintained while improving the adhesion of the counter electrode layer 340 to the second transparent conductive layer 350.

Without wishing to be tied to any particular theory, by depositing the second transparent conductive layer 350 directly in contact with the counter electrode layer 340—without any intervening layers—the electrochromic device has improved adhesion between layers and thus is able to function longer and withstand higher mechanical resistance. In one embodiment, the electrochromic stack can undergo between 2,000 and 10,000 cycles in the Nylon brush test before type 2 defects form. In another embodiment, the adhesion between the counter electrode layer 340 to the second transparent conductive layer 350 can be at least 2 J/m², as measured by the Wedge-Loaded-Double Cantilever Beam (WL-DCB) test.

The WL-DCB test measures the interface fracture toughness according to the technique outlined in “L. Alzate, Investigation experimentale de la theorie du piegeage pour l'amelioration de l'energie d'adhesion des empilements de couches minces optiques, Ph.D. thesis, Paris 6 (2012).” Specifically, a counter glass is glued using an epoxy glue to the coated glass on film side to build a “sandwich sample”. The edges of the assembly are polished and one side is slightly chamfered in order to obtain a tip for ease of opening. Then the sample is mounted on the WL-DCB set-up. In this experiment a razor blade is pushed in the side of the sample in order to open it in a controlled way. This causes the opening of the sample at the weakest interface. During the experiments the blade is pushed horizontally by 0.05 mm steps. The crack length and crack opening are obtained by taking pictures with a digital camera positioned on sample top and side. The interface toughness is then computed from the crack opening, the crack length, the glass thickness and the glass Young modulus, as described in M. Kanninen, An augmented double cantilever beam model for studying crack propagation and arrest, International Journal of fracture 9 (1) (1973) 83{92.

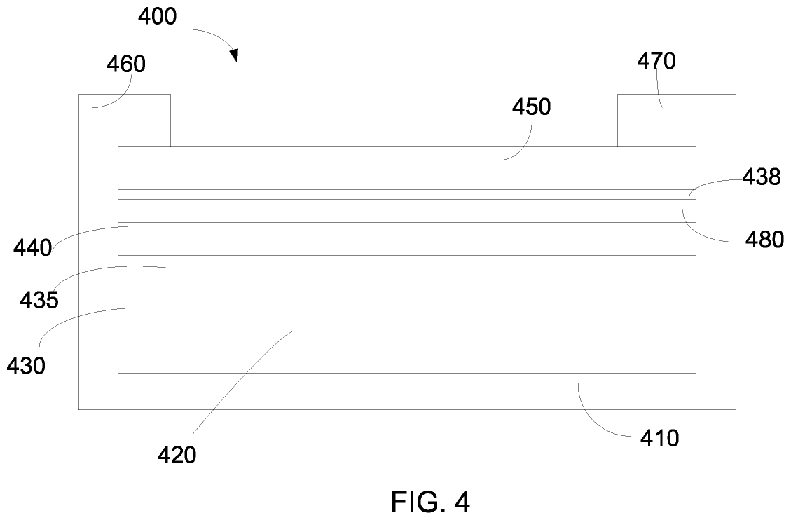

FIG. 4 includes an illustration of another electrochromic device 400, according to one embodiment. The electrochromic device 400 can a substrate 410, a first transparent conductor layer 420, an electrochromic layer 430, an electrolyte layer 435, an counter electrode layer 440, a second transparent conductor layer 450, and an adhesion layer 480. The substrate 410 can be similar to the substrate 110, the first transparent conductor layer 420 can be similar to the first transparent conductor layer 120, the electrochromic layer 430 can be similar to the electrochromic layer 130, the electrolyte layer 435 can be similar to the electrolyte layer 135, the counter electrode layer 440 can be similar to the counter electrode layer 140, and the second transparent conductor layer 450 can be similar to the second transparent conductor layer 150.

After forming the counter electrode layer 440, the adhesion layer 480 may be deposited. In one embodiment, the adhesion layer 480 can be between the counter electrode layer 440 and the second transparent conductive layer 450. In another embodiment, the adhesion layer 480 can be between the counter electrode layer 440 and a second lithium deposition layer. In yet another embodiment, the adhesion layer 480 can be deposited after the counter electrode layer 440 but before the second transparent conductive layer 450. The adhesion layer 480 can include an oxide or a nitride of a trivalent, tetravalent, or pentavalent metal. In an embodiment, the adhesion layer 480 can include TiO₂, V₂O₃, Cr₂O₃, MnO₂, FeO₂, CoO₂, Nb₂O₅, MoO₃, RhO₂, Ta₂O₅, WO₃, IrO₂, ZnO, ITO, Al₂O₃, SiO₂, ZrO₂, HfO₂, another suitable metal oxide, or the like. In another embodiment, the adhesion layer 480 can include AlN, TiN, TaN, ZrN, HfN, another suitable metal nitride, or the like. In a further embodiment, the adhesion layer 480 can have a thickness between 1 nm and 100 nm. In one embodiment, the electrochromic device can have an order of magnitude of transverse resistance per surface area of between 10⁻³ Ω·cm² to 10⁻⁹ Ω·cm², as defined by RT=ρd/A, where d is thickness, ρ is resistivity, and A is area. The adhesion layer 480 can have a negligible transverse resistance. For example an adhesion layer 480 that is 50 nm thick can have a transverse resistance of between 3×10⁻⁴ Ω·cm² and 1.5×10⁻⁵ Ω·cm². In another embodiment, the adhesion layer 480 that is 50 nm thick can have a transverse resistance of between 3×10⁻⁴ Ω·cm² and 1.5×10-⁹ Ω·cm². In another embodiment, an adhesion layer 480 that is 3 nm thick can have a transverse resistance of between 10 Ω·cm² and 3×10⁻⁸ Ω·cm². The adhesion layer 480 can also improve the electrical conductivity of the electrochromic device.

The process of forming the electrochromic device 400 can include depositing the first transparent conductive layer 420 on the substrate 410, depositing the electrochromic layer 430 on the first transparent conductive layer 420, depositing the electrolyte layer 435 on the electrochromic layer 430, depositing a first lithium layer on the electrolyte layer 435, breaking vacuum, an optional firing step, depositing the counter electrode layer 440 on the first lithium layer, depositing the adhesion layer 480 on the counter electrode layer 440, depositing a second lithium layer 438 on the adhesion layer 480, and depositing the second transparent conductive layer 450 on the second lithium layer 438. The stack of layers can then be heated to lithiate the electrochromic stack. Optionally, the process of forming the electrochromic device 400 can include a second lithium deposition step between the adhesion layer 480 and the second transparent conductive layer 450. The inventors have found that the weakest interface in an electrochemical device is between the counter electrode layer 440 and the second transparent conductive layer 450. The adhesion layer 480 within said interface, increases the adhesion between the counter electrode layer 440 and the second transparent conductive layer. As such, the adhesion layer 480 helps to reduce the likelihood of layer separation within the electrochemical device from mechanical stress and thus improves the life of the electrochromic stack. In another embodiment, the process of forming the electrochromic device 400 can include depositing the first transparent conductive layer 420 on the substrate 410, depositing the electrochromic layer 430 on the first transparent conductive layer 420, depositing the electrolyte layer 435 on the electrochromic layer 430, an optional breaking vacuum, an optional firing step, depositing the counter electrode layer 440 on the first lithium layer, depositing the adhesion layer 480 on the counter electrode layer 440, depositing a first lithium layer on the counter electrode layer 440, and depositing the second transparent conductive layer 450 on the first lithium layer 440. The stack of layers can then be heated to lithiate the electrochromic stack.

The adhesion layer 480 can be formed as a conformal layer over the counter electrode layer 440. In an embodiment, the adhesion layer 480 can be formed by atomic layer deposition (ALD). In another embodiment, the adhesion layer 480 can be formed by chemical vapor deposition (CVD). The deposition may be performed using a plasma-assisted technique or without plasma assistance. ALD can have better thickness control as compared to CVD. Accordingly, ALD is well suited to forming the adhesion layer 480.

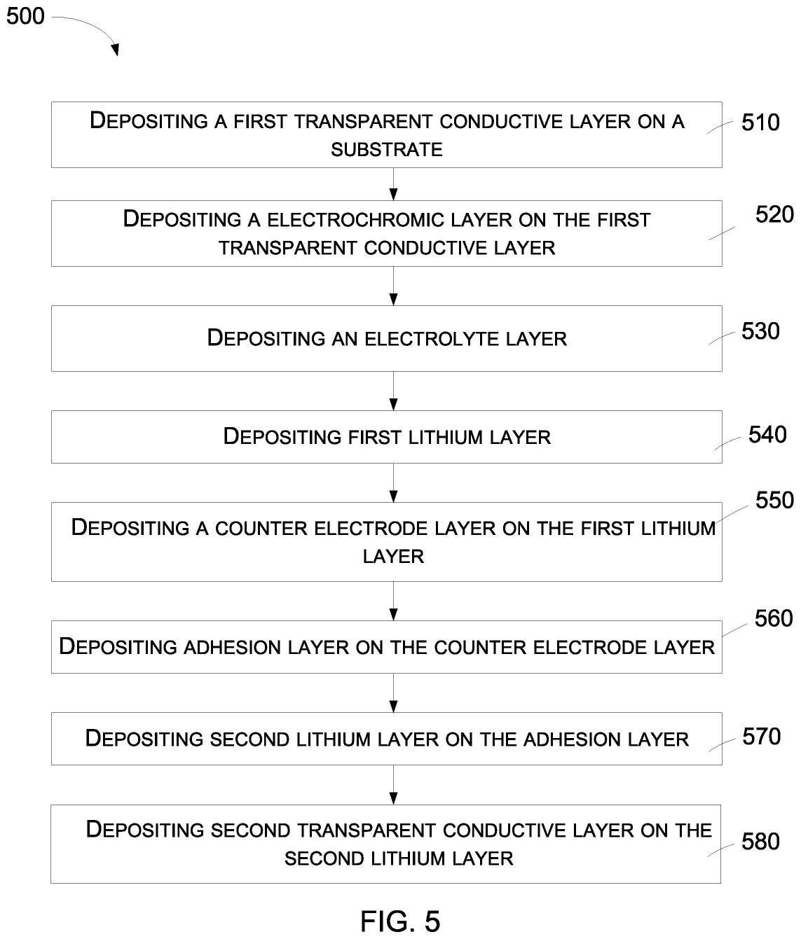

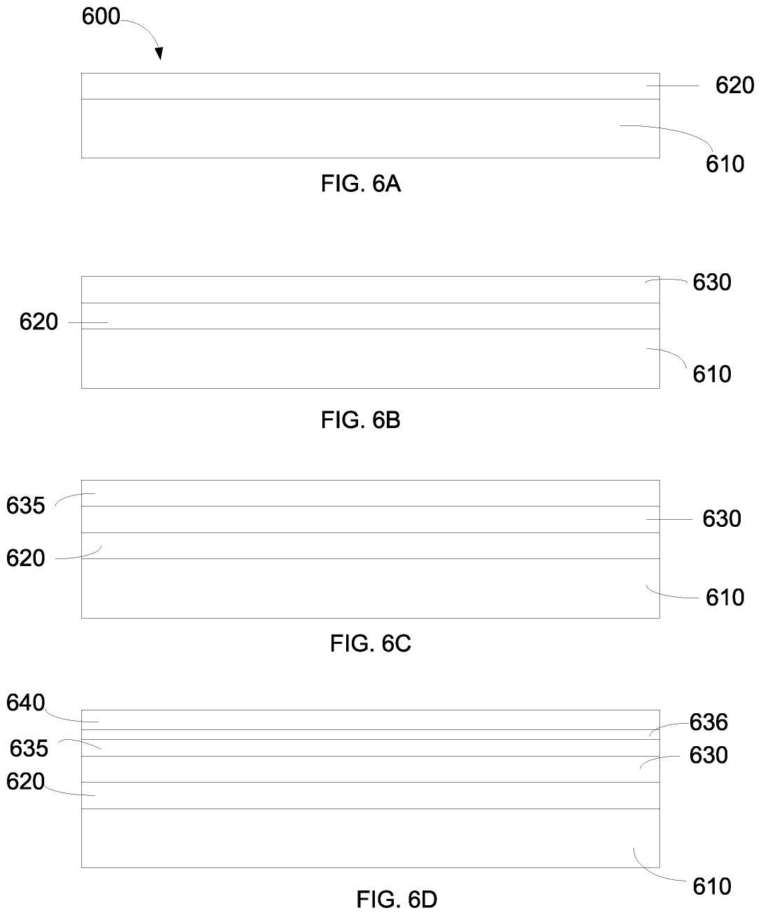

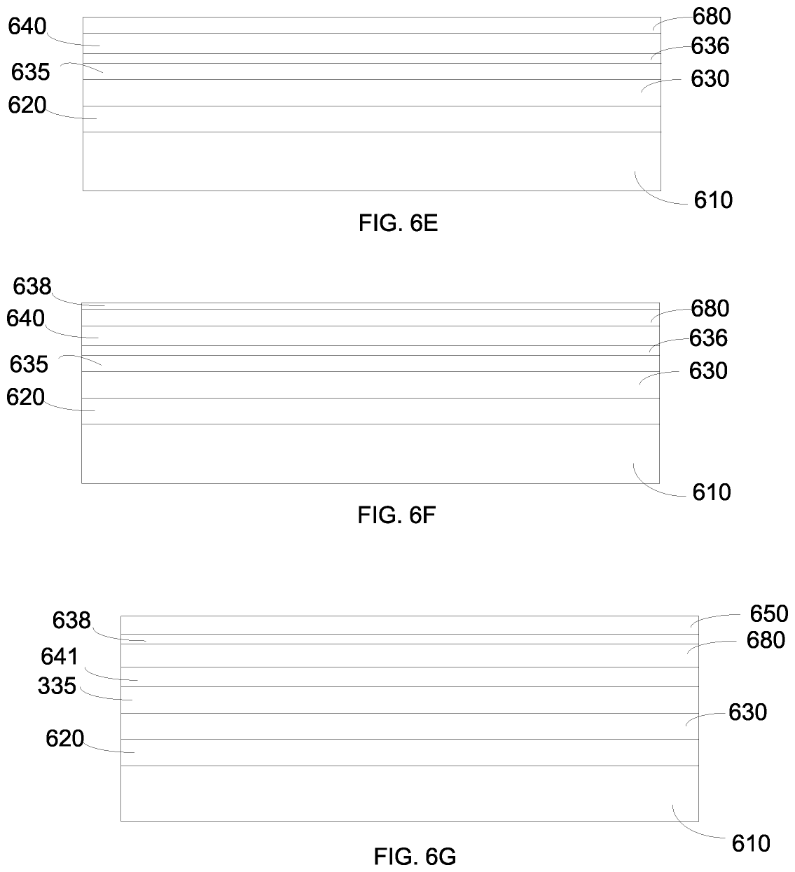

FIG. 5 is a flow chart depicting a process 500 for forming an electrochromic device in accordance with an embodiment of the current disclosure. FIGS. 6A-6G are a schematic cross-section of an electrochromic device 600 at various stages of manufacturing in accordance with an embodiment of the present disclosure. The electrochromic device 600 can be the same as the electrochromic device 400 described above. The process can include providing a substrate 610. The substrate 610 can be similar to the substrate 410 described above. At operation 510, a first transparent conductive layer 620 can be deposited on the substrate 610, as seen in FIG. 6A. The first transparent conductive layer 620 can be similar to the first transparent conductive layer 420 described above. In one embodiment, the deposition of the first transparent conductive layer 620 can be carried out by sputter deposition at a power of between 5 kW and 20 kW, at a temperature between 20° C. and 500° C., in a sputter gas including oxygen and argon at a rate between 0.1 m/min and 0.5 m/min. In one embodiment, the sputter gas includes between 40% and 80% oxygen and between 20% and 60% argon. In one embodiment, the sputter gas includes 50% oxygen and 50% argon. In one embodiment, the temperature of sputter deposition can be between 23° C. and 350° C. In one embodiment, the first transparent conductive layer 620 can be carried out by sputter deposition at a power of between 10 kW and 15 kW.

In one embodiment, an intermediate layer can be deposited between the substrate 610 and the first transparent conductive layer 620. In an embodiment, the intermediate layer can include an insulating layer such as an antireflective layer. The antireflective layer can include a silicon oxide, niobium oxide, or any combination thereof. In a particular embodiment, the intermediate layers can be an antireflective layer that can be used to help reduce reflection. The antireflective layer may have an index of refraction between the underlying layers (refractive index of the underlying layers can be approximately 2.0) and clean, dry air or an inert gas, such as Ar or N₂ (many gases have refractive indices of approximately 1.0). In an embodiment, the antireflective layer may have a refractive index in a range of 1.4 to 1.6. The antireflective layer can include an insulating material having a suitable refractive index. In a particular embodiment, the antireflective layer may include silica. The thickness of the antireflective layer can be selected to be thin and provide the sufficient antireflective properties. The thickness for the antireflective layer can depend at least in part on the refractive index of the electrochromic layer 630 and counter electrode layer 640. The thickness of the intermediate layer can be in a range of 20 nm to 100 nm.

At operation 520 and as seen in FIG. 6B, an electrochromic layer 630 may be deposited on the first transparent conductive layer 620. The electrochromic layer 630 can be similar to the electrochromic layer 430 described above. In one embodiment, the deposition of the electrochromic layer 630 may be carried out by sputter deposition of tungsten, at a temperature between 23° C. and 500° C., in a sputter gas including oxygen and argon. In one embodiment, the sputter gas includes between 40% and 80% oxygen and between 20% and 60% argon. In one embodiment, the sputter gas includes 50% oxygen and 50% argon. In one embodiment, the temperature of sputter deposition is between 100° C. and 350° C. In one embodiment, the temperature of sputter deposition is between 200° C. and 300° C. An additionally deposition of tungsten may be sputter deposited in a sputter gas that includes 100% oxygen.

At operation 530 and as seen in FIG. 6C, an electrolyte layer 635 may be deposited on the electrochromic layer 630. The electrolyte layer 635 can be similar to the electrolyte layer 435 described above. In one embodiment, the deposition of the electrolyte layer 635 may be carried out by sputter deposition of silica, lithium at a power of between 5 kW and 12 kW. In one embodiment, the power is pulsed. In another embodiment, the sputter target can be rotated to point away from the substrate. The deposition of the electrolyte layer may be at a temperature between 23° C. and 500° C. in a sputter gas including oxygen and argon. In one embodiment, the temperature of sputter deposition is between 150° C. and 450° C. In another embodiment, the deposition of the electrolyte layer 635 may be carried out in a sputter gas including between 0% and 5% oxygen and between 100% to 95% argon. In one embodiment, the sputter gas includes between 40% and 80% oxygen and between 20% and 60% argon. In one embodiment, the electrolyte layer 635 may be deposited to form a layer with a thickness between 1 nm and 12 nm. In one embodiment, the metal layer may have a thickness of no greater than 5 nm, such as no greater than 4 nm, no greater than 3 nm, no greater than 2 nm, or no greater than 1 nm.

At operation 540, a first lithium layer 636 deposition may occur. In one embodiment the lithium layer 636 may be sputtered on top of the electrolyte layer 635. As will be discussed later, the lithium layer 636 may diffuse into the counter electrode layer 640 during a firing step. The lithiation of the counter electrode layer 640 may be completed before the deposition of any subsequent layers, such as the second electrode layer 660. In one embodiment, after sputtering additional lithium on the electrolyte layer 635, the stack of layers can break vacuum. In another embodiment, lithiation can occur in a controlled environment, without vacuum break, but instead by introducing an oxidizing agent into the controlled environment.

In one embodiment the substrate 610, the first transparent conductive layer 620, the electrolyte layer 635, and the electrochromic layer 630 may be heated at a temperature between 23° C. and 500° C. in atmospheric air for between 1 min. and 30 min. In other words, the substrate and subsequent deposited layers may break vacuum before being heated. In one embodiment, the substrate and subsequent layers may be heated in atmospheric air for between 1 min. and 5 min. The substrate 610, the first transparent conductive layer 620, the electrolyte layer 635, and the electrochromic layer 630 may be heated by the plasma source before subsequent deposition of layers. In one embodiment, substrate 610, the first transparent conductive layer 620, the electrolyte layer 635, and the electrochromic layer 630 may be heated at a temperature between 200° C. and 500° C.

At operation 550, and as seen in FIG. 6D, after heating the layers, a counter electrode layer 640 may be deposited on the lithium layer 636. The counter electrode layer 640 can be similar to the counter electrode layer 440 described above. In one embodiment, the deposition of the counter electrode layer 640 may be carried out by sputter deposition of tungsten, nickel, and lithium, at a temperature between 20° C. and 50° C., in a sputter gas including oxygen and argon. In one embodiment, the sputter gas includes between 60% and 80% oxygen and between 20% and 40% argon. In one embodiment, the temperature of sputter deposition is between 22° C. and 32° C.

At operation 560, and as seen in FIG. 6E, an adhesion layer 680 may be deposited on the counter electrode layer 640. The adhesion layer 680 may be similar to adhesion layer 480. The adhesion layer 480 within said interface increases the adhesion between the counter electrode layer 640 and the second transparent conductive layer 650. As such, the adhesion layer 680 helps to reduce the likelihood of layer separation within the electrochemical device from mechanical stress and thus improves the life of the electrochromic stack. The adhesion layer 680 can be formed as a conformal layer over the counter electrode layer 640. The adhesion layer 680 while improving the adhesion between the counter electrode layer 640 and the second transparent conductive layer 650, also allows lithium to migrate to the counter electrode layer 640. In an embodiment, the adhesion layer 680 can be formed by atomic layer deposition (ALD). In another embodiment, the adhesion layer 680 can be formed by chemical vapor deposition (CVD). The deposition may be performed using a plasma-assisted technique or without plasma assistance. ALD can have better thickness control as compared to CVD. Accordingly, ALD is well suited to forming the adhesion layer 680.

At operation 570, and as seen in FIG. 6F, a second lithium layer 638 deposition may occur. In one embodiment the lithium layer 638 may be sputtered on top of the adhesion layer 680. The second lithium layer 638 can be similar to the first lithium layer 636. The adhesion layer 680 may allow the lithium from the second lithium layer 638 to migrate into the counter electrode layer 640. At operation 580, a second transparent conductive layer 650 may be deposited on the second lithium layer 638. The second transparent conductive layer 650 can be similar to the second transparent conductive layer 450 described above. In one embodiment, the deposition of the second transparent conductive layer 650 may be carried out by sputter deposition at a power of between 5 kW and 20 kW, at a temperature between 20° C. and 50° C., in a sputter gas including oxygen and argon. In one embodiment, the sputter gas includes between 1% and 10% oxygen and between 90% and 99% argon. In one embodiment, the sputter gas includes 8% oxygen and 92% argon. In one embodiment, the temperature of sputter deposition is between 22° C. and 32° C. In one embodiment, the substrate 610, first transparent conductive layer 620, the electrochromic layer 630, the electrolyte layer 635, the first lithium layer 636, the counter electrode layer 640, the adhesion layer 680, the second lithium layer 638, and the second transparent conductive layer 650 may be heated a at a temperature between 300° C. and 500° C. for between 2 min and 10 min. In one embodiment, the stack is heated at a temperature between 500° C. and 450° C. In one embodiment, the substrate 610, first transparent conductive layer 620, the electrochromic layer 630, the electrolyte layer 635, the first lithium layer 636, the counter electrode layer 640, the adhesion layer 680, the second lithium layer 638, and the second transparent conductive layer 650 may be heated a at a temperature between 300° C. and 500° C. for between 2 min and 10 min. In one embodiment, the stack is heated at a temperature between 500° C. and 450° C. As the stack is heated, the lithium layer 636 deposited in between the electrolyte layer 635 and the counter electrode layer 640 may be diffused into the counter electrode layer 640 forming a lithiated counter electrode layer 641, as seen in FIG. 6G.

In one embodiment, additional layers may be deposited on the second transparent conductive layer 650. Any of the electrochemical devices can be subsequently processed as a part of an insulated glass unit. Overtime and after repeated wear from mechanical stress, layers within the electrochemical device can begin to separate and degrade. The inventors have discovered that in general the interface most susceptible to degradation is between the counter electrode layer and the second transparent conductive layer. As such, over time the interface between those two layers begins to degrade causing the electrochemical device to fail. However, by manufacturing an electrochemical device as described above, specifically with an adhesion layer 680, the adhesion between the counter electrode layer and the second transparent conductive layer improves while maintaining the ion mobility necessary for switching between a clear state and tinted state. In other words, the functionality of the counter electrode layer 640 is maintained while improving the adhesion of the counter electrode layer 640 to the second transparent conductive layer 650.

Without wishing to be tied to any particular theory, by depositing the adhesion layer 680 between the second transparent conductive layer 650 and the counter electrode layer 640, the electrochromic device has improved adhesion between layers and thus is able to function longer and withstand higher mechanical resistance. In one embodiment, the electrochromic stack can undergo between 2,000 and 10,000 cycles in the Nylon brush test before type 2 defects form. In another embodiment, the adhesion between the counter electrode layer 340 to the second transparent conductive layer 350 can be at least 2 J/m², as measured by the WL-DCB test.

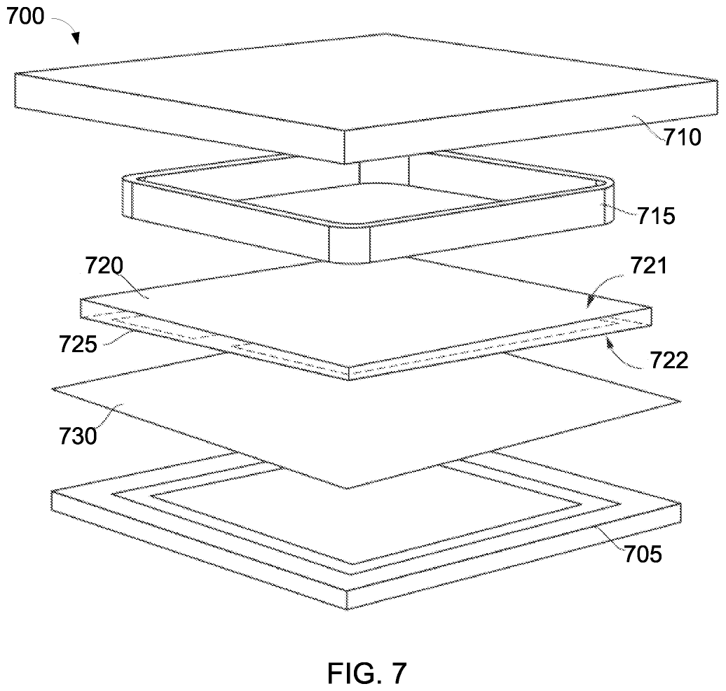

FIG. 7 is a schematic illustration of an insulated glazing unit 700 according the embodiment of the current disclosure. The insulated glass unit 700 can include a first panel 705, an electrochemical device 720 coupled to the first panel 705, a second panel 710, and a spacer 715 between the first panel 705 and second panel 710. The first panel 705 can be a glass panel, a sapphire panel, an aluminum oxynitride panel, or a spinel panel. In another embodiment, the first panel can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The first panel 705 may or may not be flexible. In a particular embodiment, the first panel 705 can be float glass or a borosilicate glass and have a thickness in a range of 2 mm to 20 mm thick. The first panel 705 can be a heat-treated, heat-strengthened, or tempered panel. In one embodiment, the electrochemical device 720 is coupled to first panel 705. In another embodiment, the electrochemical device 720 is on a substrate 725 and the substrate 725 is coupled to the first panel 705. In one embodiment, a lamination interlayer 730 may be disposed between the first panel 705 and the electrochemical device 720. In one embodiment, the lamination interlayer 730 may be disposed between the first panel 705 and the substrate 725 containing the electrochemical device 720. The electrochemical device 720 may be on a first side 721 of the substrate 725 and the lamination interlayer 730 may be coupled to a second side 722 of the substrate 725. The first side 721 may be parallel to and opposite from the second side 722.

The second panel 710 can be a glass panel, a sapphire panel, an aluminum oxynitride panel, or a spinel panel. In another embodiment, the second panel can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The second panel may or may not be flexible. In a particular embodiment, the second panel 710 can be float glass or a borosilicate glass and have a thickness in a range of 5 mm to 30 mm thick. The second panel 710 can be a heat-treated, heat-strengthened, or tempered panel. In one embodiment, the spacer 715 can be between the first panel 705 and the second panel 710. In another embodiment, the spacer 715 is between the substrate 725 and the second panel 710. In yet another embodiment, the spacer 715 is between the electrochemical device 720 and the second panel 710.

In another embodiment, the insulated glass unit 700 can further include additional layers. The insulated glass unit 700 can include the first panel 705, the electrochemical device 720 coupled to the first panel 705, the second panel 710, the spacer 715 between the first panel 705 and second panel 710, a third panel, and a second spacer (not shown) between the first panel 705 and the second panel 710. In one embodiment, the electrochemical device may be on a substrate. The substrate may be coupled to the first panel using a lamination interlayer. A first spacer may be between the substrate and the third panel. In one embodiment, the substrate is coupled to the first panel on one side and spaced apart from the third panel on the other side. In other words, the first spacer may be between the electrochemical device and the third panel. A second spacer may be between the third panel and the second panel. In such an embodiment, the third panel is between the first spacer and second spacer. In other words, the third panel is couple to the first spacer on a first side and coupled to the second spacer on a second side opposite the first side.

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the ones as listed below.

Embodiment 1. A method of forming an electrochromic device, including: depositing a first transparent conductive layer on a substrate; depositing a second transparent conductive layer; depositing an electrochromic layer between the first transparent conductive layer and the second transparent conductive layer; depositing a counter electrode layer between the first transparent conductive layer and the second transparent conductive layer; depositing an electrolyte layer between the electrochromic layer and the counter electrode layer; depositing at least one mobile element, where the mobile element is not deposited directly on either the electrochromic layer or the counter electrode layer; and heating the first transparent conductive layer, the electrochromic layer, the mobile element, the counter electrode layer, the electrolyte layer, and the second transparent conductive layer to form an electrochromic stack.

Embodiment 2. An electrochromic device, including: a first transparent conductive layer; a second transparent conductive layer; an electrochromic layer between the first transparent conductive layer and the a second transparent conductive layer; a counter electrode layer between the first transparent conductive layer and the a second transparent conductive layer; and an electrolyte layer between the electrochromic layer and the counter electrode layer, where the electrochromic device can undergo at least 2000 cycles in a Nylon brush test before type 2 defects form, and where the electrochromic device is functional.

Embodiment 3. A method of forming an electrochromic device, including: depositing a first transparent conductive layer; depositing an electrochromic layer over the first transparent conductive layer; depositing an electrolyte layer over the electrochromic layer; depositing at least one mobile element over the electrolyte layer; depositing a counter electrode layer over the at least one mobile element lithium layer; depositing a second transparent conductive layer over the counter electrode layer; and heating the first transparent conductive layer, the electrochromic layer, the electrolyte layer, the at least one mobile element lithium layer, counter electrode layer, and the second transparent conductive layer to form an electrochromic stack, where only a single deposition of at least one mobile element is performed in the method of forming the electrochromic device.

Embodiment 4. An electrochromic device prepared by a process including the steps of: depositing a first transparent conductive layer; depositing an electrochromic layer over the first transparent conductive layer; depositing an electrolyte layer over the electrochromic layer; depositing at least one mobile element over the electrolyte layer; depositing a counter electrode layer over the at least one mobile element; depositing a second transparent conductive layer over the counter electrode layer; and heating the first transparent conductive layer, the electrochromic layer, the electrolyte layer, the at least one mobile element, counter electrode layer, and the second transparent conductive layer to form an electrochromic stack, where the electrochromic device can undergo 2000 cycles in a Nylon brush test before type 2 defects form.

Embodiment 5. A method of forming an electrochromic device, including: depositing a first transparent conductive layer on a substrate; depositing an electrochromic layer over the first transparent conductive layer; depositing an electrolyte layer over the electrochromic layer; depositing a counter electrode layer over the at least one mobile element; depositing an adhesion layer over the counter electrode layer; depositing a second transparent conductive layer over the counter electrode layer; depositing at least one mobile element between the adhesion layer and the second transparent conductive layer; and heating the first transparent conductive layer, the electrochromic layer, the electrolyte layer, the at least one mobile element, counter electrode layer, and the second transparent conductive layer to form an electrochromic stack, where only a single deposition of at least one mobile element is performed in the method of forming the electrochromic device.

Embodiment 6. An electrochromic device prepared by a process including the steps of: depositing a first transparent conductive layer; depositing an electrochromic layer over the first transparent conductive layer; depositing an electrolyte layer over the electrochromic layer; depositing a counter electrode layer over the at least one mobile element; depositing an adhesion layer over the counter electrode layer; depositing a second transparent conductive layer over the adhesion layer; depositing at least one mobile element between the adhesion layer and the second transparent conductive layer; and heating the first transparent conductive layer, the electrochromic layer, the electrolyte layer, the at least one mobile element, counter electrode layer, the adhesion layer and the second transparent conductive layer to form an electrochromic stack, and where the electrochromic device can undergo 2000 cycles in a Nylon brush test before type 2 defects form.

Embodiment 7. An electrochromic device, including: a first transparent conductive layer; a second transparent conductive layer; an electrochromic layer between the first transparent conductive layer and the a second transparent conductive layer; a counter electrode layer between the first transparent conductive layer and the a second transparent conductive layer; an electrolyte layer between the electrochromic layer and the counter electrode layer; and an adhesion layer between the counter electrode layer and the second transparent conductive layer, where the electrochromic device can undergo at least 2000 cycles in a Nylon brush test before type 2 defects form, and where the electrochromic device is functional.

Embodiment 8. The method of any one of embodiments 1, 3, or 5, where the mobile metal includes a material selected from the group consisting of lithium, sodium, hydrogen, and silver.

Embodiment 9. The method of embodiment 8, where the first transparent conductive layer, the second transparent conductive layer, or both is lithiated.

Embodiment 10. The method of embodiment 1, further including depositing an adhesion layer between the counter electrode layer and the second transparent conductive layer.

Embodiment 11. The method of embodiment 10, where a first mobile metal is deposited directly on the electrolyte layer.

Embodiment 12. The method of embodiment 11, where a second mobile metal is deposited directly on the adhesion layer.

Embodiment 13. The method of embodiment 10, the at least one mobile metal is deposited directly on the adhesion layer.

Embodiment 14. The method of embodiment 1, where the electrochromic device can undergo 2,000 cycles in a Nylon brush test before type 2 defects form.

Embodiment 15. The method of any one of embodiments 1, 3 or 5, further including breaking vacuum after depositing the mobile metal over the electrolyte layer.

Embodiment 16. The method of any one of embodiments 3 or 5, further including heating the first transparent conductive layer, the electrochromic layer, the electrolyte layer, and the mobile metal prior to any subsequent layer deposition.

Embodiment 17. The electrochromic device or method of any of the preceding embodiments, where the mobile metal is combined with the counter electrode layer after heating the first transparent conductive layer, the electrochromic layer, the electrolyte layer, the mobile metal, counter electrode layer, and the second transparent conductive layer to form the electrochromic stack.

Embodiment 18. The electrochromic device of any one of embodiments 2, 4, 6, or 7, or the method of any one of embodiments 1, 3, or 5, where the second transparent conductive layer is in direct contact with the counter electrode layer.

Embodiment 19. The electrochromic device of embodiment 6 or the method of embodiments 8 to 10, where the adhesion layer is conformal.

Embodiment 20. The electrochromic device or method of any one of the preceding embodiments, where the electrochromic device can undergo between 2,000 and 10,000 cycles in the Nylon brush test before type 2 defects form.

Embodiment 21. The electrochromic device or method of any one of the preceding embodiments, further including a second lithium deposition between the adhesion layer and the second transparent conductive layer.

Embodiment 22. The electrochromic device or method of any one of the preceding embodiments, where the adhesion layer has a thickness of in a range of 1 nm to 200 nm.

Embodiment 23. The electrochromic device or method of any one of the preceding embodiments, where the adhesion layer includes a metal oxide.

Embodiment 24. The electrochromic device or method of any one of the preceding embodiments, where the adhesion layer includes a material selected from the group consisting of TiO₂, V₂O₃, Cr₂O₃, MnO₂, FeO₂, CoO₂, Nb₂O₅, MoO₃, RhO₂, Ta₂O₅, WO₃, IrO₂, ZnO, ITO, Al₂O₃, SiO₂, ZrO₂, HfO₂, AlN, TiN, TaN, ZrN, HfN, and any combination therein.

Embodiment 25. The electrochromic device or method of any one of the preceding embodiments, where the adhesion layer has a transverse resistance of between 10 and 1.5×10-9 Ω·cm², as defined by RT=ρd/A, where d is thickness, ρ is resistivity, and A is area.

Embodiment 26. The electrochromic device or method of any one of the preceding embodiments, where the adhesion layer has a transverse resistance of between 10 and 1.5×10-8 Ω·cm², as defined by RT=ρd/A, where d is thickness, ρ is resistivity, and A is area.

Embodiment 27. The electrochromic device or method of any one of the preceding embodiments, where the adhesion layer has a transverse resistance of between 3×10-4 and 1.5×10-5 Ω·cm², as defined by RT=ρd/A, where d is thickness, ρ is resistivity, and A is area.

Embodiment 28. The electrochromic device or method of any one of the preceding embodiments, where the electrochromic material includes WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

Embodiment 29. The electrochromic device or method of any one of the preceding embodiments, where the substrate includes glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, another suitable transparent polymer, co-polymer of the foregoing, float glass, borosilicate glass, or any combination thereof.

Embodiment 30. The electrochromic device or method of any one of the preceding embodiments, where the first transparent conductive layer includes indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

Embodiment 31. The electrochromic device or method of any one of the preceding embodiments, where the second transparent conductive layer includes indium oxide, indium tin oxide, doped indium oxide, tin oxide, doped tin oxide, zinc oxide, doped zinc oxide, ruthenium oxide, doped ruthenium oxide and any combination thereof.

Embodiment 32. The electrochromic device or method of any one of the preceding embodiments, where the anodic electrochemical layer includes a an inorganic metal oxide electrochemically active material, such as WO₃, V₂O₅, MoO₃, Nb₂O₅, TiO₂, CuO, Ir₂O₃, Cr₂O₃, Co₂O₃, Mn₂O₃, Ta₂O₅, ZrO₂, HfO₂, Sb₂O₃, a lanthanide-based material with or without lithium, another lithium-based ceramic material, a nickel oxide (NiO, Ni₂O₃, or combination of the two), and Li, nitrogen, Na, H, or another ion, any halogen, or any combination thereof.

Embodiment 33. The method of any one of embodiments 1, 3, or 5, where no lithiation is performed between the deposition of the electrochromic layer and the counterelectrode layer.

Embodiment 34. The electrochromic device of any one of embodiments 2, 4, 6, or 7, where the electrochromic device does not include a lithium layer between the electrochromic layer and the counterelectrode layer.

Embodiment 35. The electrochromic device or method of any one of the preceding embodiments, where an adhesion between the counter electrode layer to the second transparent conductive layer can be at least 2 J/m², as measured by the WL-DCB test.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the embodiments.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An electrochromic device, comprising:
a first transparent conductive layer;
a second transparent conductive layer;
an electrochromic layer between the first transparent conductive layer and the a second transparent conductive layer;
a counter electrode layer between the first transparent conductive layer and the a second transparent conductive layer; and
an electrolyte layer between the electrochromic layer and the counter electrode layer, wherein the electrochromic device can undergo at least 2000 cycles in a Nylon brush test before type 2 defects form, and wherein the electrochromic device is functional.

2. The electrochromic device of claim 1, further comprising a mobile metal, and wherein the mobile metal is combined with the counter electrode layer after heating the first transparent conductive layer, the electrochromic layer, the electrolyte layer, the mobile metal, counter electrode layer, and the second transparent conductive layer to form the electrochromic stack.

3. The electrochromic device of claim 1, wherein the second transparent conductive layer is in direct contact with the counter electrode layer.

4. The electrochromic device of claim 1, further comprising an adhesion layer over the counter electrode layer, and wherein the adhesion layer is conformal.

5. The electrochromic device of claim 1, wherein the electrochromic device can undergo between 2,000 and 10,000 cycles in the Nylon brush test before type 2 defects form.

6. The electrochromic device of claim 4, further comprising a second lithium layer between the adhesion layer and the second transparent conductive layer.

7. The electrochromic device of claim 4, wherein the adhesion layer has a thickness of between 1 nm and 200 nm.

8. The electrochromic device of claim 4, wherein the adhesion layer comprises a metal oxide.

9. The electrochromic device of claim 4, wherein the adhesion layer comprises a material selected from the group consisting of TiO₂, V₂O₃, Cr₂O₃, MnO₂, FeO₂, CoO₂, Nb₂O₅, MoO₃, RhO₂, Ta₂O₅, WO₃, IrO₂, ZnO, ITO, Al₂O₃, SiO₂, ZrO₂, HfO₂, AlN, TiN, TaN, ZrN, HfN, and any combination therein.

10. The electrochromic device of claim 4, wherein the adhesion layer has a transverse resistance of between 10 and 1.5×10⁻⁹ Ω·cm², as defined by RT=ρd/A, wherein d is thickness, ρ is resistivity, and A is area.

11. The electrochromic device of claim 4, wherein the adhesion layer has a transverse resistance of between 10 and 1.5×10⁻⁸ Ω·cm², as defined by RT=ρd/A, wherein d is thickness, ρ is resistivity, and A is area.

12. The electrochromic device of claim 4, wherein the adhesion layer has a transverse resistance of between 3×10⁻⁴ and 1.5×10⁻⁵ Ω·cm2, as defined by RT=ρd/A, wherein d is thickness, ρ is resistivity, and A is area.

13. An electrochromic device prepared by a process comprising the steps of:
depositing a first transparent conductive layer;
depositing an electrochromic layer over the first transparent conductive layer;
depositing an electrolyte layer over the electrochromic layer;
depositing at least one mobile element over the electrolyte layer;
depositing a counter electrode layer over the at least one mobile element;
depositing a second transparent conductive layer over the counter electrode layer; and
heating the first transparent conductive layer, the electrochromic layer, the electrolyte layer, the at least one mobile element, counter electrode layer, and the second transparent conductive layer to form an electrochromic stack, wherein the electrochromic device can undergo 2000 cycles in a Nylon brush test before type 2 defects form.

14. The electrochromic device of claim 13, wherein the electrochromic device does not comprise a lithium layer between the electrochromic layer and the counterelectrode layer.

15. The electrochromic device of claim 13, further comprising an adhesion wherein an adhesion between the counter electrode layer to the second transparent conductive layer can be at least 2 J/m², as measured by the WL-DCB test.

16. A method of forming an electrochromic device, comprising:
depositing a first transparent conductive layer on a substrate;
depositing a second transparent conductive layer;
depositing an electrochromic layer between the first transparent conductive layer and the second transparent conductive layer;
depositing a counter electrode layer between the first transparent conductive layer and the second transparent conductive layer;
depositing an electrolyte layer between the electrochromic layer and the counter electrode layer;
depositing at least one mobile element, wherein the mobile element is not deposited directly on either the electrochromic layer or the counter electrode layer; and
heating the first transparent conductive layer, the electrochromic layer, the mobile element, the counter electrode layer, the electrolyte layer, and the second transparent conductive layer to form an electrochromic stack.

17. The method of claim 16, wherein the first transparent conductive layer, the second transparent conductive layer, or both is lithiated.

18. The method of claim 16, further comprising depositing an adhesion layer between the counter electrode layer and the second transparent conductive layer.

19. The method of claim 16, wherein the electrochromic device can undergo 2000 cycles in a Nylon brush test before type 2 defects form.

20. The method of claim 16, wherein a first mobile metal is deposited directly on the electrolyte layer.
